(19) United States
(12) Patent Application Publication
(10) Pub. No.: US 2012/0198627 A1
(43) Pub. Date: Aug. 9, 2012

(54) Occupant Support with Multi-Modal Control

(76) Inventors: Jonathan D. Turner, Dillsboro, IN (US); Brian Mears, Batesville, IN (US)

(21) Appl. No.: 13/368,862

(22) Filed: Feb. 8, 2012

Related U.S. Application Data
(60) Provisional application No. 61/440,589, filed on Feb. 8, 2011.

(51) Int. Cl. A61G 7/018; A61G 7/008; A61G 7/015

(52) U.S. Cl. 5/610; 5/600; 5/611; 5/613; 5/697

(57) ABSTRACT

An adjustable bed (20) includes a base frame (30) and an occupant support system (32) operable in two or more modes of operation. A user control (90), which may be a rocker pedal (100) is capable of assuming at least two identities, each corresponding to one of the two or more modes of operation. A mode selector (122) allows a user to select an identity for the user control. Selection of the user control identity enables a user to use the user control to govern the mode of operation corresponding to the selected identity.

### TECHNICAL FIELD

The subject matter described herein relates to patient supports, such as adjustable beds of the type used in hospitals, and particularly to a bed having a user control capable of mutually exclusive governance of each of two or more selectable modes of bed operation depending on the state of a mode selector.

### BACKGROUND

Adjustable beds are capable of a number of modes of operation. For example, many hospital beds include a base frame and an intermediate frame which can be raised or lowered relative to the base frame. Raising or lowering the intermediate frame is a mode of operation. Such beds may also include a segmented deck comprising two or more deck sections supported on the intermediate frame such that the angular orientation of at least one of the sections can be increased or decreased relative to the intermediate frame. Increasing or decreasing the angular orientation of the deck section is a second mode of operation.

In one known example, the two modes of operation are governed by four pedals. A user depresses one pedal to increase the elevation of the intermediate frame, depresses a second pedal to decrease the elevation of the intermediate frame, depresses a third pedal to increase the orientation of the deck section and depresses the fourth pedal to decrease the orientation of the deck section. The presence of four pedals for governing two modes of operation can result in undesirable physical clutter and added manufacturing cost. Even if the frame elevation and deck orientation were governed by, for example, a touch screen graphical user interface mounted on one of the bed siderails, the presence of four touch sensitive fields to govern only two modes of operation could result in visual clutter.

### SUMMARY

An adjustable bed includes a base frame and an occupant support system operable in two or more modes of operation. A user control capable of assuming at least two identities, each corresponding to one of the two or more modes of operation, is associated with the bed. A mode selector allows a user to select an identity for the user control. Selection of the user control identity enables a user to use the user control to govern the mode of operation corresponding to the selected identity.

### BRIEF DESCRIPTION OF THE DRAWINGS

The foregoing and other features of the various embodiments of the bed or patient support described herein will become more apparent from the following detailed description and the accompanying drawings in which:

FIG. 1 is a schematic, cross sectional side elevation view of a hospital bed excluding siderails.

FIG. 2 is a perspective view of a hospital bed including the siderails not illustrated in FIG. 1.

FIGS. 3A and 3B are a plan view and a side elevation view of a multifunctional user control for the bed of FIGS. 1 and 2, the user control being in the form of a pedal assembly having a pedal with an information display area and a mode selector thereon.

FIG. 4 is an enlargement of the information display area visible in FIG. 3A.

FIG. 5 is a chart showing sample dislays for indicating which of two or more operational modes has been selected for the pedal assembly of FIGS. 3A-3B.

FIG. 6 is a view similar to that of FIG. 2 showing a user control comprising two pedals and also showing a siderail integrated arrangement for the information display area and mode selector of FIG. 3A.

FIG. 7 is a view similar to that of FIG. 6 showing a siderail mounted user control, mode selector and information display area.

FIG. 8 is a view similar to that of FIG. 6 showing a user control in the form of a single pedal capable of assuming exactly two identities.

FIG. 9 is an enlarged view of the pedal of FIG. 8.

FIG. 10 is a view similar to that of FIG. 8 showing a less preferred user control in the form of a pedal capable of assuming two identities.

FIG. 11 is a view similar to that of FIG. 8 showing a user control in the form of a pedal capable of assuming three identities.

FIG. 12 is a set of diagrams contrasting the bed described herein and its operation with a more conventional bed and its operation.

### DETAILED DESCRIPTION

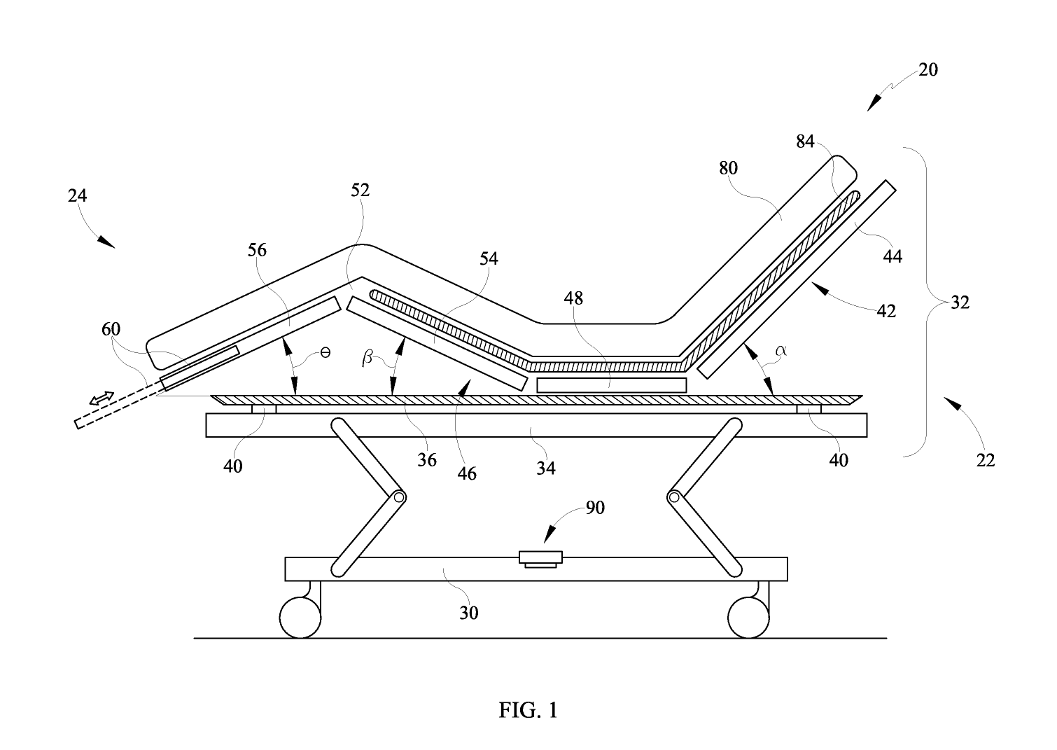

Referring to FIG. 1, a hospital bed 20 extends longitudinally from a head end 22 to a foot end 24 and laterally from a left side (seen in the plane of the illustrations) to a right side. The bed comprises a base frame 30, and an occupant support system 32 The occupant support system includes an intermediate frame 34 mounted on the base frame such that the intermediate frame can be raised or lowered in elevation relative to the base frame. The occupant support system also includes a weigh frame 36 mounted on the intermediate frame such that the load path from the weigh frame to the intermediate frame extends through load cells 40. The load cells enable measurement of the weight of an occupant of the bed. The occupant support system also includes a segmented deck 42 comprising an upper body section 44 corresponding approximately to the occupant's torso, and a lower body section 46. The lower body section includes a seat section 48 corresponding approximately to the occupant's buttocks and a leg section 52, which further comprises a thigh section 54 corresponding approximately to the occupant's thighs and a calf section 56 corresponding approximately to the occupant's calves and feet. The angular orientations α, β, θ of the upper body, thigh and calf sections are adjustable.

The occupant support system also includes a deck adjustment panel 60 translatably attached to the calf deck section. The adjustment panel can be translated in the footward or headward directions to increase or decrease the overall length of the deck, as illustrated with dashed lines, in order to accommodate occupants of different heights.

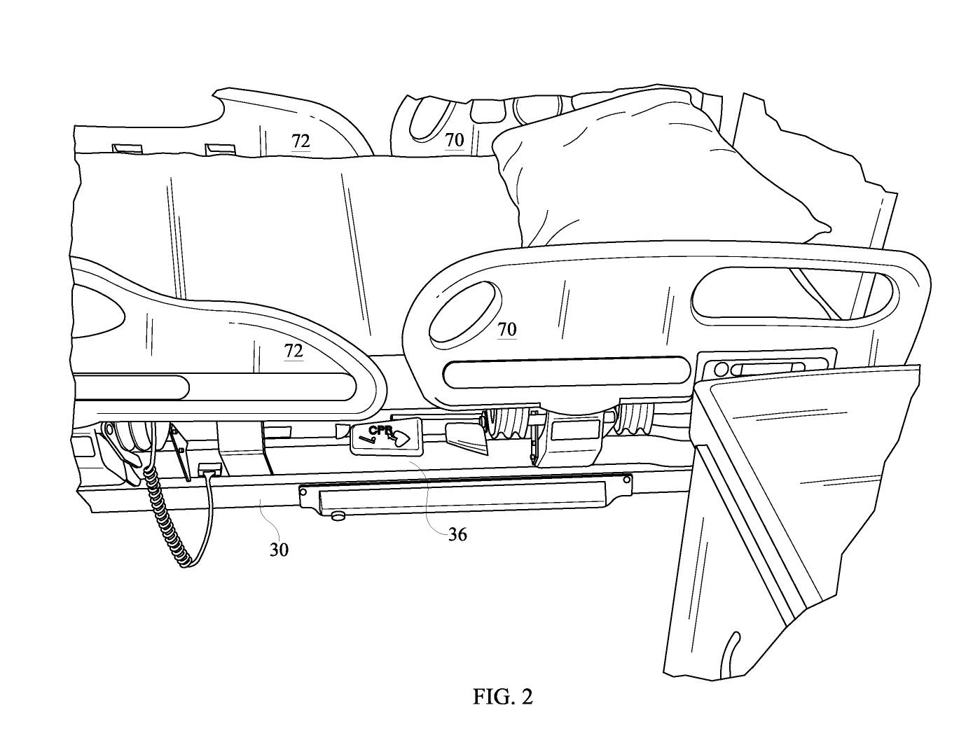

Referring additionally to FIG. 2, left and right head end siderails 70 are attached to upper body deck section 44; left and right foot end siderails 72 are attached to the weigh frame 36.

The occupant support system also includes a mattress 80 having sufficient flexibility to conform to the bed profile defined by the orientations α, β, θ of the articulable deck sections 44, 54, 56. The mattress may be made of foam or other cushioning material. Alternatively, the mattress may comprise air bladders whose firmness can be adjusted by introducing air into the bladders or by venting air from the bladders. The mattress may also be a combination foam and bladder mattress.

In some beds the occupant support system may also include laterally left and right turn assist bladders 84 residing between the deck and the mattress. When it is necessary for a caregiver to turn a bed occupant laterally, one of the turn assist bladders can be inflated to assist the caregiver in executing the turn. For example if the caregiver wishes to turn a supine occupant to his or her right, the caregiver would inflate the left turn assist bladder. The turn assist bladders can also be used to apply rotational therapies. Such therapies include Continuous Lateral Rotation Therapy (CLRT), which involves slowly inflating and deflating the turn assist bladders out of phase with each other in order to gently turn the bed occupant alternately to the left and right by about 20°-45° in each direction. The alternate turning helps resist fluid accumulation in the occupant's lungs, mobilizes secretions already present in the lungs, and increases aeration of the lungs. Another example rotational therapy is Lateral Pressure Relief (LPR) which involves a similar left to right cycling of about 10° to guard against the onset of decubitus ulcers.

The occupant support system is operable in two or more modes of operation. One mode of operation is an elevation mode in which the elevation or height of the intermediate frame can be adjusted. A second mode is an inclination mode in which the overall inclination of the intermediate frame can be adjusted. A third mode is a weigh mode in which the the weight measured by load cells 40 is displayed or recorded. A fourth mode is an upper body rotational mode in which the angular orientation α of the upper body deck section 44 is adjusted. A fifth mode is a leg contour mode in which the angular orientations β, θ of the thigh and calf deck sections are adjusted. A sixth mode is a profile mode in which all three deck angles α, β, θ are adjusted. A seventh mode is a length mode in which deck extension 60 is extended or retracted to adjust the length of the bed. An eighth mode is a mattress firmness mode in which a pump and/or aspirator are used to pump air into or remove air from support bladders to adjust mattress firmness. A ninth mode is a turn assist mode in which one of the turn assist bladders 84 is inflated. The foregoing is a sampling of the various operational modes of the occupant support system rather than an exhaustive enumeration of all possible modes.

Although not shown in the illustrations, the bed also includes appropriate actuators, pumps and related hardware and software to effect the above described adjustments to the components of the occupant support system.

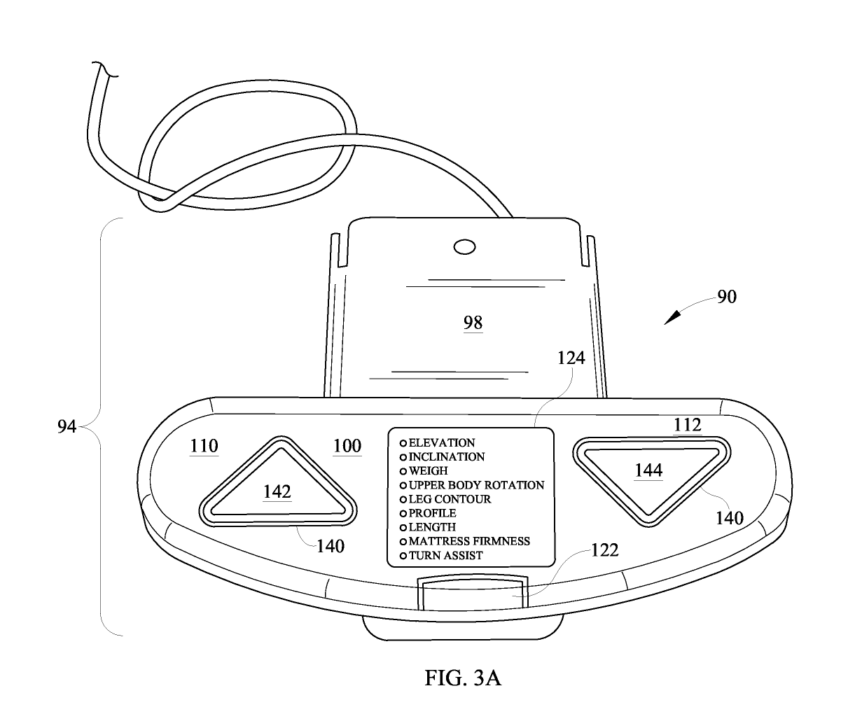

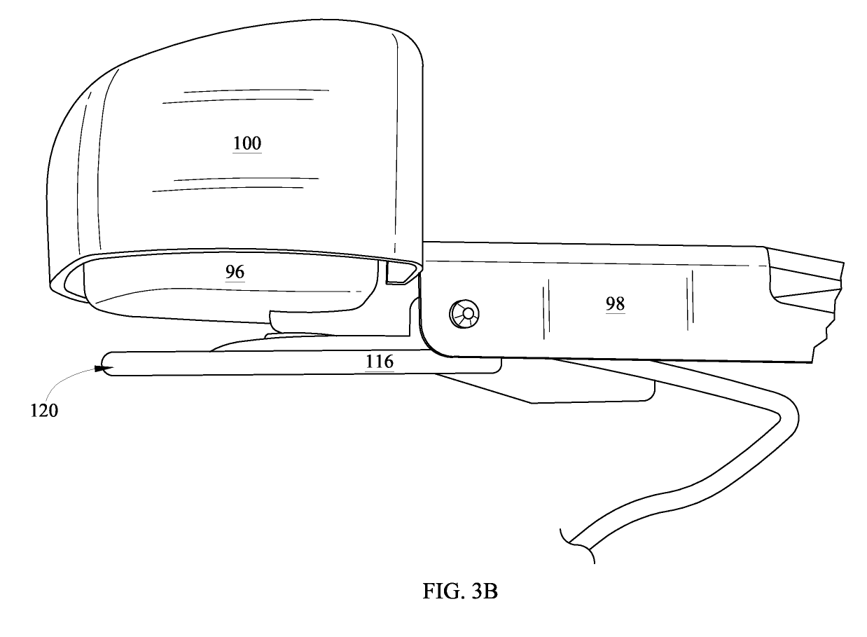

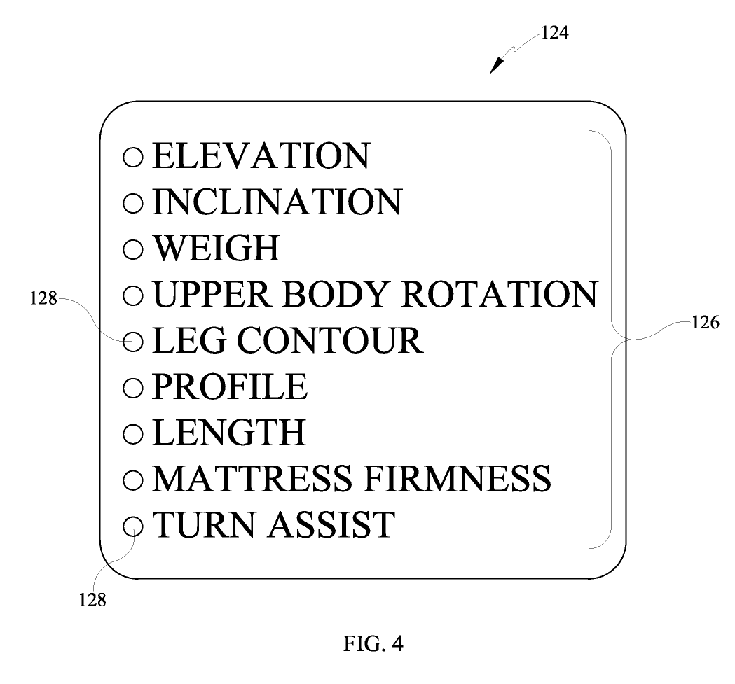

Referring additionally to FIGS. 3A-3B and 4, the bed also includes a user control 90 capable of assuming at least two identities. In the illustration the user control is in the form of at least one pedal 92. For example, FIGS. 3A-3B show a rocker pedal assembly 94 including a base 96, a bracket 98 extending from the base for mounting the pedal assembly to base frame 30 of the bed, and a user control 90 exemplified by rocker pedal 100. The rocker pedal includes left and right foot pad portions 110, 112 and is pivotably mounted on base 96 so that a force applied to the left foot pad causes the pedal to rock to the left and close a first switch (not visible) whereas a force applied to the right foot pad causes the pedal to rock to the right and close a right switch (also not visible). The pedal assembly also includes an paddle switch plate 116 hinged to bracket 98. The paddle switch plate is spring biased so that its non-hinged edge 120 is vertically spaced from the underside of the pedal base. The pedal also includes a mode selector button 122 and an information display area 124 between the foot pads. As seen in more detail in FIG. 4, the information display area includes a listing 126 of selectable operational modes of the occupant support system and a light emitting diode (LED) 128 next to each member of the list to indicate which mode has been selected.

Mode selector button 122 is used for selecting an identity for the user control, e.g. an identity to be assigned to the pedal and corresponding to a mode of operation. In operation, a user first presses up on paddle switch 116, which causes the pedal assembly to change state from disabled to enabled. In the absence of the paddle switch, and the need to use it to effect the state change, pressure accidentally applied to the pedal could cause unintentional operation of the bed. Once the user has enabled the pedal assembly, he can tap the selector button with his foot to cause a change in the identity of the pedal as indicated by the illuminated LED. For example a user who activates the pedal assembly and finds that the LED next to the length operational mode is illuminated can tap the selector three more times to select the elevation mode. The paddle switch can also serve as the mode selector. Initial use of the paddle switch carries out the enablement described above. Additional taps on the switch advance through the available mode selections. After the switch is inactive for a preset period of time it returns to its disabled state.

Each selected identity corresponds to one of the two or more modes of operation. For example, if the user selected the elevation operational mode as described above, the pedal would assume the identity of an elevation control. Pressure applied to one of the foot pads (e.g. the left foot pad) would cause the appropriate actuators to move the intermediate frame to an increasingly higher elevation until the user released the pedal or an upper limit were reached. Pressure applied to the other (right) foot pad would cause the appropriate actuators to move the intermediate frame to an increasingly lower elevation until the user released the pedal or a lower limit were reached. If the user then tapped the selector button seven more times, the pedal would assume the identity of a mattress firmness control. Pressure applied to one of the foot pads (e.g. the left foot pad) would cause a pump to supply air to the mattress to increase mattress firmness until the user released the pedal (or a maximum limit were achieved). Conversely, pressure applied to the other (right) foot pad would open an exhaust valve or operate a vacuum device to remove air from the mattress until the user released the pedal (or a minimum limit were reached) thereby reducing mattress firmness.

The illustration of the information display shows nine possible identities that the pedal or other user control can assume, each identity corresponding to one of the modes of opeation of the occupant support system described above. These identities and modes of operation include the elevation and firmness modes described in the foregoing example. The other modes are described briefly in the following paragraphs.

In the inclination mode the pedal or other user control governs angular orientation of the intermediate frame relative to the base frame. Pressure applied to one of the pedal foot pads tilts the frame in one rotational sense (e.g. clockwise); pressure applied to the other foot pad tilts the frame in the opposite rotational sense (e.g. counterclockwise).

In the weigh mode, pressure applied to either of the pedal foot pads causes the weight borne by load cells 40 to be displayed or recorded. In one practical embodiment pressure applied to one foot pad causes the weight to be displayed or recorded in metric units (e.g. kg); pressure applied to the other foot pad causes the weight to be displayed or recorded in English units (e.g. pounds).

In the upper body section rotational mode the pedal or other user control governs the angular orientation α of the upper body deck section 44. Pressure applied to one of the pedal foot pads increases the orientation angle α; pressure applied to the other pedal foot pad decreases the orientation angle α.

In the leg contour mode the pedal or other user control governs the angular orientations β, θ of the thigh and calf sections 54, 56. Pressure applied to one of the pedal foot pads increases the orientation angles β, θ; pressure applied to the other pedal foot pad decreases the orientation angle β, θ.

In the profile mode the pedal or other user control governs the angular orientations α, β, θ of the upper body, thigh and calf sections 44, 54, 56. Pressure applied to one of the pedal foot pads increases the orientation angles α, β, θ; pressure applied to the other pedal foot pad decreases the orientation angles α, β, θ.

In the length mode the pedal or other user control governs extension and retraction of extension panel 60. Pressure applied to one of the pedal foot pads extends the panel to increase the length of the bed; pressure applied to the other foot pad retracts the panel.

In the turn assist mode the pedal or other user control governs inflation of one of the turn assist bladders 84 in order to provide turn assist to the left or right. Pressure applied to one of the pedal foot pads inflates the right turn assist bladder; pressure applied to the other foot pad inflates the left turn assist bladder.

In all the above examples except the weigh mode, operation of the affected bed components ceases when the user releases pressure on the foot pad or when a component reaches a limit such as a minimum or maxumum angular orientation or a minimum or maximum bladder pressure.

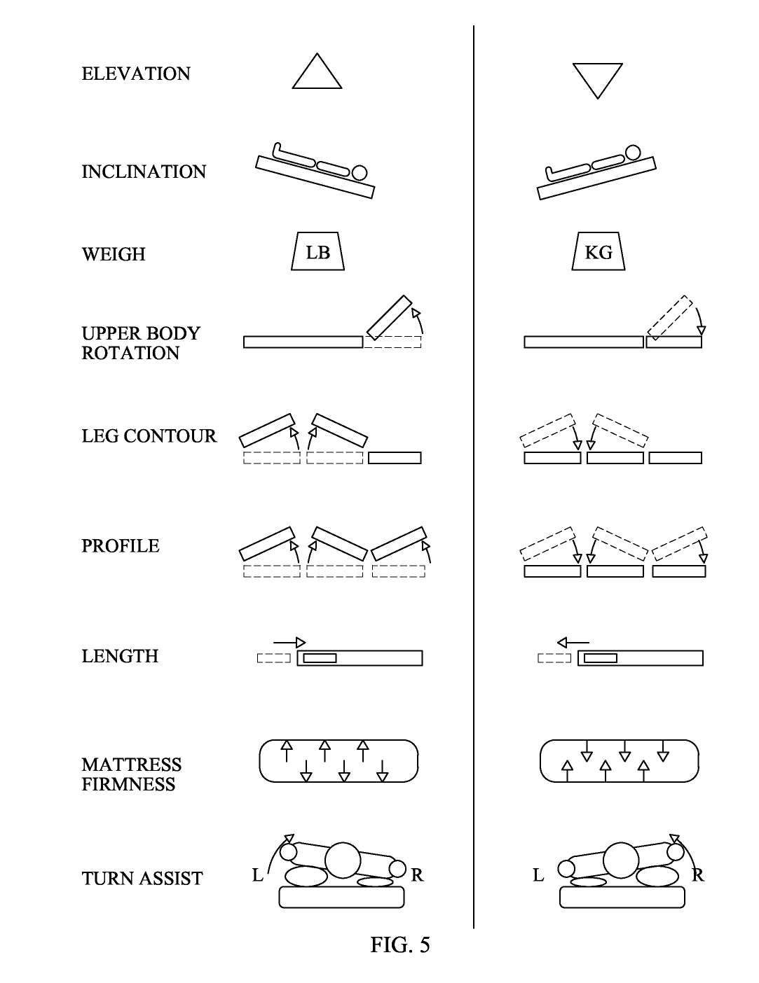

Referring back to FIG. 3A the foot pads include graphical displays 140 to suggest relevant characteristics of the selected mode of operation. Many of these characteristics are opposing directional characteristics, such as up versus down, increased angle versus decreased angle, and increased bladder pressure versus decreased bladder pressure. In the weigh mode example given above, the relevant, mode specific characteristic is the units (metric or English) in which the weight is displayed or recorded. For some groups of operational modes and corresponding user control (pedal) identities, the same graphical image may serve as an equally intuitive indicator. For example an up-arrow 142 on one foot pad and a down-arrow 144 on the other foot pad as seen in FIG. 3A would be an intuitive directional indicator for the elevation mode where the up-arrow can indicate the foot pad to be used to increase the elevation of the intermediate frame and the down-arrow can indicate the foot pad to be used to decrease the elevation of the intermediate frame. The same directional arrows can also serve as an equally intuitive indicator if the user selected the upper body rotational mode. For that mode, the up-arrow can indicate the foot pad to be used to increase the orientation angle α, and the down-arrow can indicate the foot pad to be used to decrease the orientation angle α. Similarly, these same directional arrows could also serve as an intuitive indicator if the user selected the mattress firmness mode. The up-arrow can then indicate the foot pad to be used to increase mattress firmness and the down-arrow can then indicate the foot pad to be used to decrease mattress firmness. However for other operational modes and corresponding pedal identities the up-arrow and down-arrow would likely be non-intuitive or even counterintuitive. In such an instance the graphical display can be a variable display that changes depending on the selected operational mode. If a variable display is employed, the system designer can provide different graphical images even for modes of operation and pedal identities that could, in principle, use identical images, thereby rendering the display even more intuitive. In addition, any given display can be animated to suggest the component behavior that will result. FIG. 5 shows several sample displays.

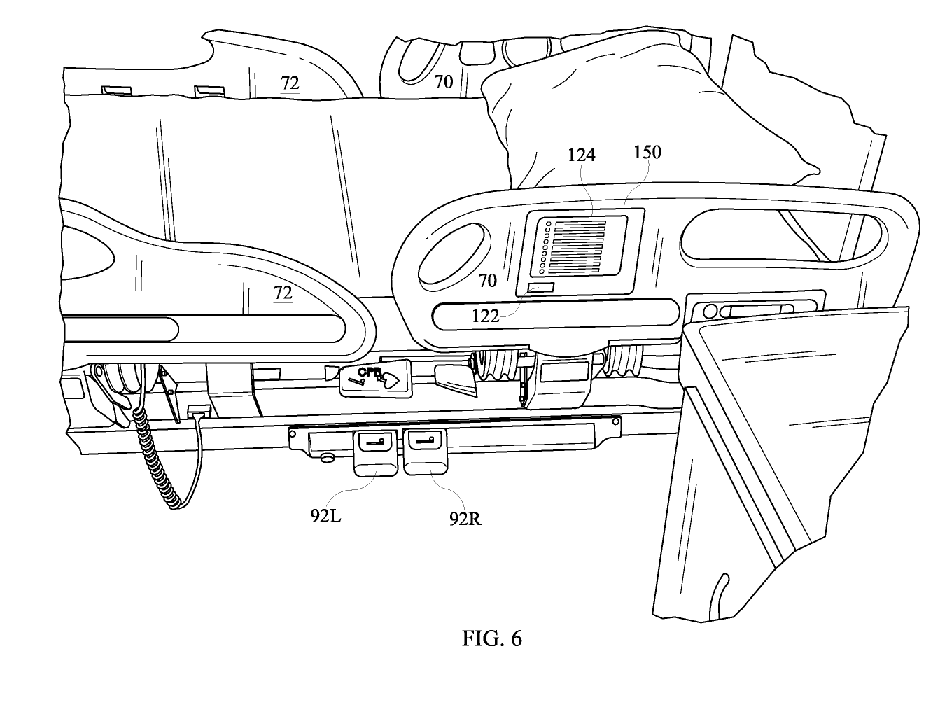

In the above examples and discussion the user control is a rocker pedal. The user control could also be a pair of controls such as the dual pedals 92L, 92R shown in FIG. 6. The pedals control characteristics, such as opposing directional characteristics, of whichever operational mode has been slected by way of the mode selector. For example if the elevation mode were selected, pedal 92L could be used to lower the elevation of intermediate frame 34 and pedal 92R could be used to raise the elevation of the intermediate frame. If the upper body rotational mode were selected, pedal 92L could be used to decrease the angular orientation of upper body deck section 44 and pedal 92R could be used to increase the angular orientation of the upper body deck section.

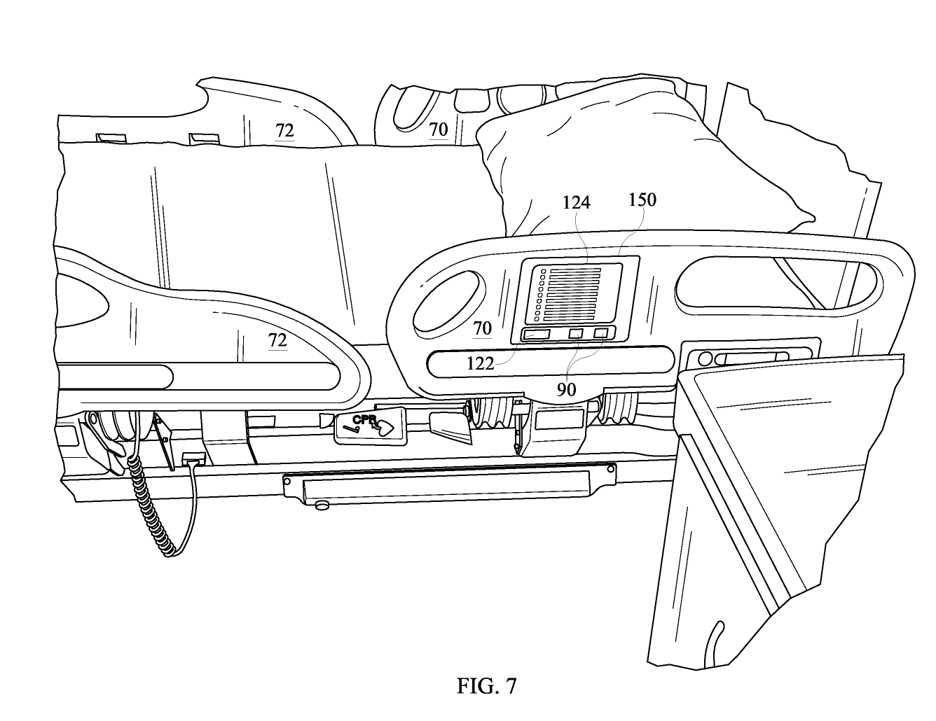

In the above examples and discussion the user control is one or more pedals, the mode selector 122 is a button mounted on the pedal (or can be the paddle switch 116) and the information display is a display screen also mounted on the pedal. However other types of components can be used, as can other distributions of the components. For example the user control can be one or more pedals as already described (e.g. 92L, 92R, 100) but, as seen in FIG. 6, the mode selector 122 and information display 124 can be presented on a touch screen mounted on siderail 70 where the information displayed on the display will be easier to see and where the environment for the display and the mode selector is less hostile. In another example seen in FIG. 7, user control 90 and mode selector 122 can be presented on a finger operated interface 150 such as a touch screen display mounted on the siderail and the information display 124 can also be mounted on the siderail.

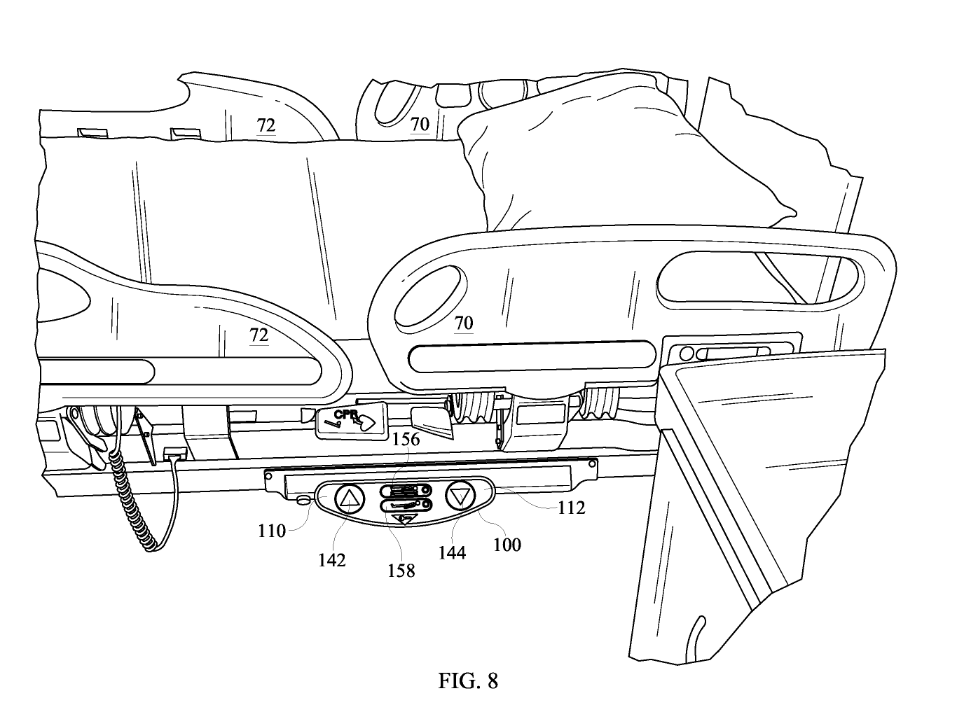

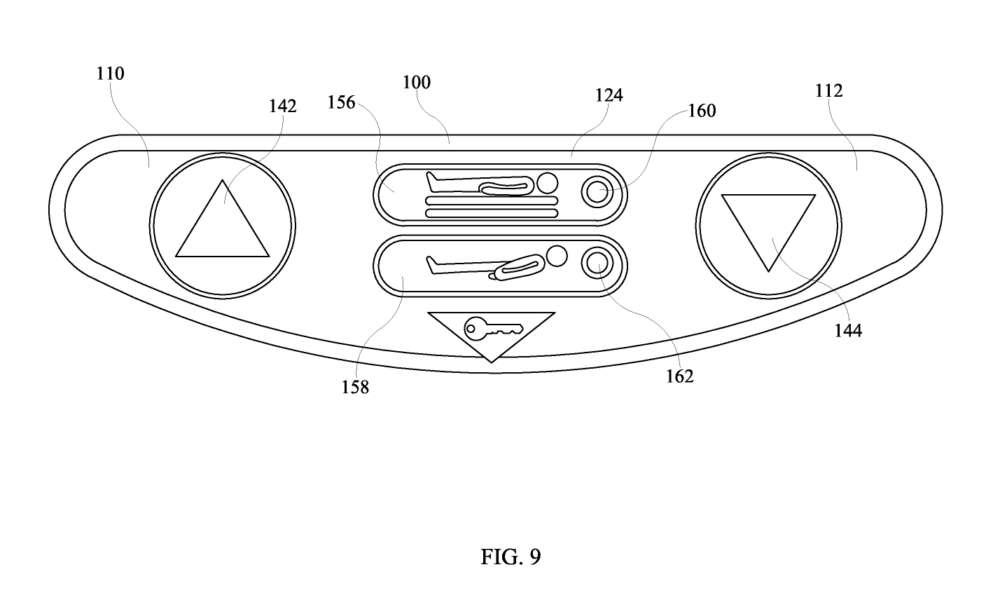

FIGS. 8-9 show one specific example in which the user control is a rocker pedal 100 as described above and is capable of assuming exactly two identities. One identity corresponds to an elevation mode of operation and the other identity corresponds to an upper body rotational mode of operation. Information display area 124 of the pedal includes two images 156, 158, each accompanied by an LED 160, 162. If the user selects the elevation mode of operation, LED 156 illuminates to indicate that the elevation mode has been selected, which enables the user to employ the user control (pedal) to govern elevation of the bed, specifically elevation of the intermediate frame. Applying pressure to left footpad 110 causes the elevation of intermediate frame 34 to increase whereas application of pressure to right footpad 112 causes the elevation of intermediate frame 34 to decrease. If the user selects the upper body rotational mode, LED 162 is illuminated to indicate that the upper body rotational mode has been selected, which enables the user to employ the same pedal to govern angular orientation of the upper body deck section of the bed. Applying pressure to left footpad 110 causes the angular orientation α of upper body deck section 44 to increase whereas application of pressure to right footpad 112 causes the angular orientation α of upper body deck section 44 to decrease. In the example of FIGS. 8-9 the mode selector is the paddle switch 116 (FIGS. 3A-3B) or a selector mounted elsewhere in the bed.

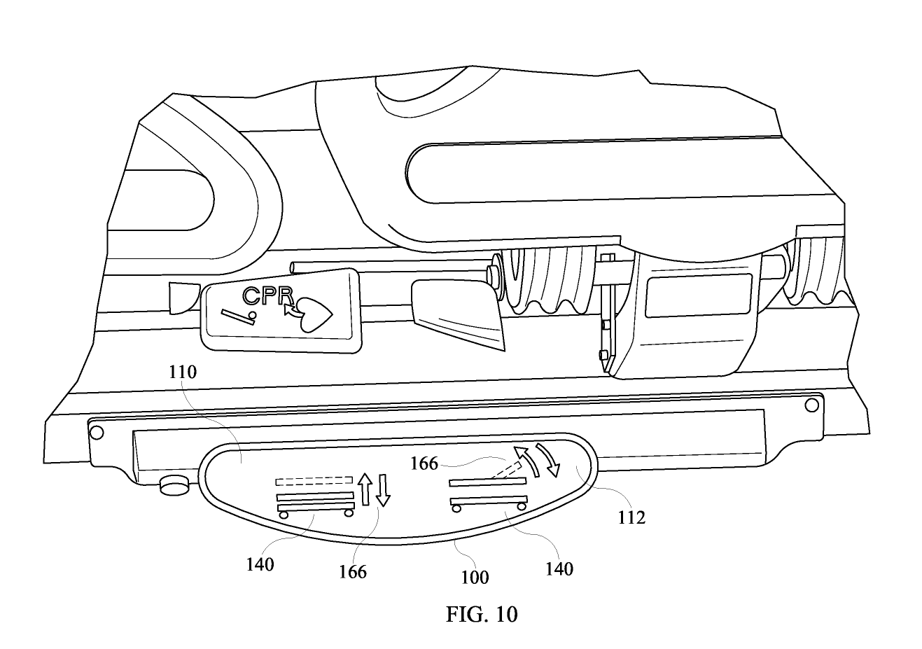

FIG. 10 shows a less preferred variant where, once again, the user control is capable of assuming exactly two identities. In this case one of the identities corresponds to an UP mode of operation and the other identity corresponds to a DOWN mode. User selection of the UP mode enables the user to employ the user control, in particular left foot pad 110, to increase elevation of the bed (specifically the intermediate frame 34) and to employ right foot pad 112 to increase the orientation angle α of the upper body deck section 44 of the bed. User selection of the DOWN mode enables the user to employ the user control, in particular left foot pad 110, to decrease elevation of the bed (specifically the intermediate frame) and to employ right foot pad 112 to decrease the orientation angle α of the upper body section of the bed. The foot pads include graphical displays 140 to indicate the functionality of each footpad. The illustration also shows a feature in which one of two directional arrows 166 associated with each indicator 140 is illuminated to indicate the operational mode (UP versus DOWN).

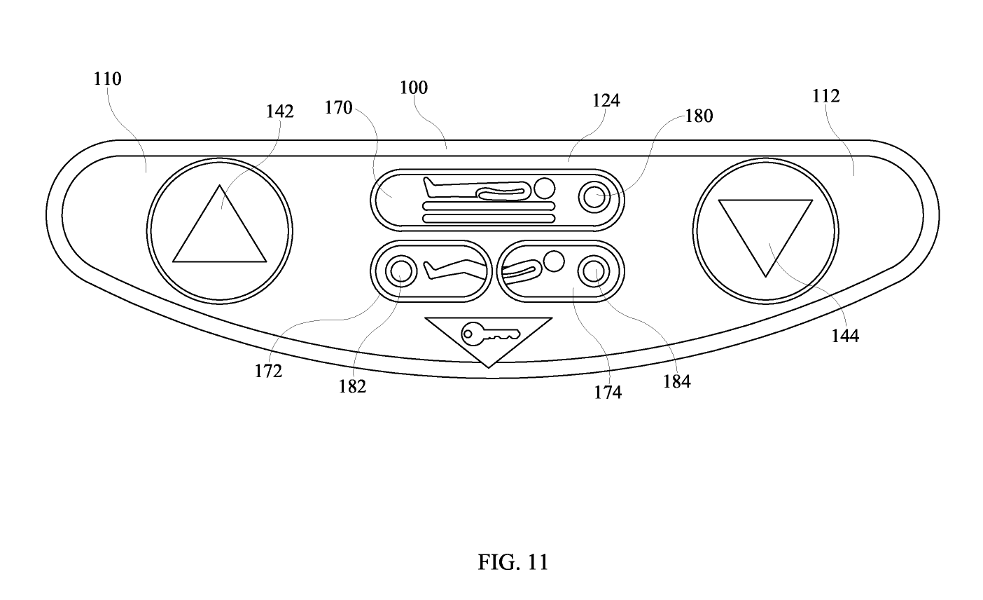

FIG. 11 is a view similar to that of FIG. 9 showing another specific example in which the user control is a rocker pedal 100 as described above and is capable of assuming three identities. One identity corresponds to an elevation mode of operation, a second identity corresponds to a leg profile mode of operation and the third identity corresponds to an upper body rotational mode of operation. Information display area 124 of the pedal includes three images 170, 172, 174 each accompanied by an LED 180, 182, 184. If the user selects the elevation mode of operation, LED 180 illuminates to indicate that the elevation mode has been selected, which enables the user to employ the user control (pedal) to govern elevation of the bed, specifically elevation of the intermediate frame. Applying pressure to left footpad 110 causes the elevation of intermediate frame 34 to increase whereas application of pressure to right footpad 112 causes the elevation of intermediate frame 34 to decrease. If the user selects the leg contour mode of operation, LED 182 illuminates to indicate that the leg contour mode has been selected, which enables the user to employ the user control (pedal) to govern the leg contour of the bed, specifically angular orientations β, θ of thigh and calf sections 54, 56. Applying pressure to left footpad 110 causes angles β, θ to increase whereas application of pressure to right footpad 112 causes angles β, θ to decrease. If the user selects the upper body rotational mode, LED 184 is illuminated to indicate that the upper body rotational mode has been selected, which enables the user to employ the same pedal to govern angular orientation of an upper body deck section of the bed. Applying pressure to left footpad 110 causes the angular orientation α of upper body deck section 44 to increase whereas application of pressure to right footpad 112 causes the angular orientation α of upper body deck section 44 to decrease. In the example of FIG. 11 the mode selector is the paddle switch 116 (FIGS. 3A-3B) or a selector mounted elsewhere in the bed.

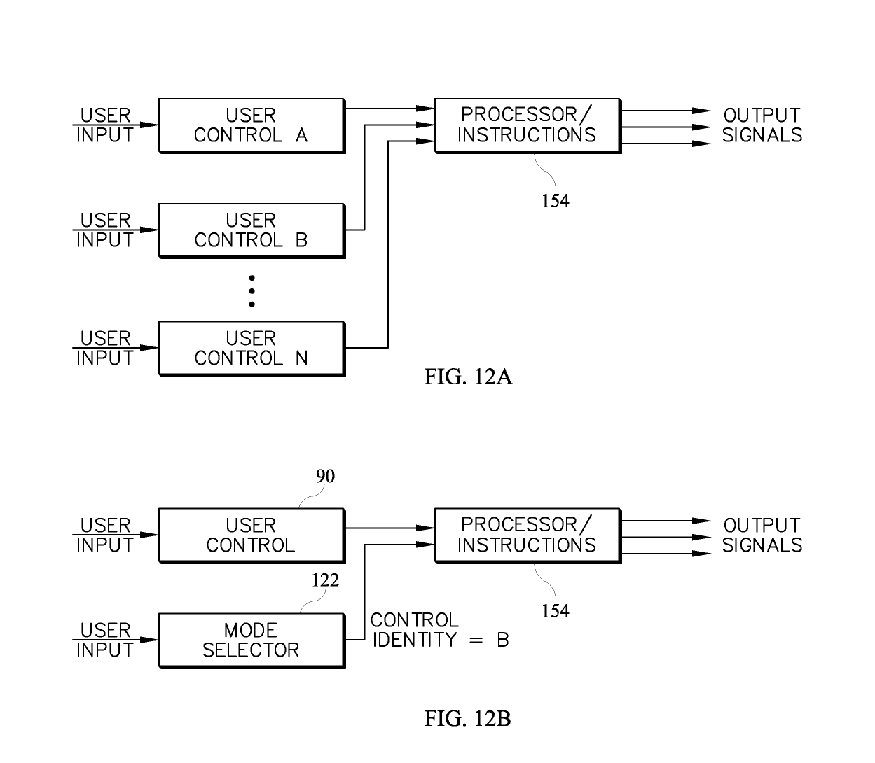

FIGS. 12A and 12B are diagrams contrasting the above described bed and its operation with a more conventional bed and its operation. In the conventional approach of FIG. 12A, a user applies a user input to one of two or more user controls, for example to user control B. In response, a processor 154 executes instructions specific to that user control, causing the generation of one or more output signals which command appropriate operation of appropriate bed components (e.g. motors, actuators, pumps). The output signals differ depending on which control the user has used. In the innovative approach of FIG. 12B the user uses the mode selector 122 to assign an identity to a single user control 90 and then applies an input to the single user control. In the example the user has selected mode B (which corresponds to user control B of the conventional approach). In response the processor 154 executes instructions specific to mode B, causing the generation of the output signals for commanding operation of the appropriate bed components.

Although this disclosure refers to specific embodiments, it will be understood by those skilled in the art that various changes in form and detail may be made without departing from the subject matter set forth in the accompanying claims.

We claim:

1. An adjustable bed comprising:
a base frame;
an occupant support system operable in two or more modes of operation;
a user control capable of assuming at least two identities, each identity corresponding to one of the two or more modes of operation;
a selector for selecting an identity for the user control whereby selection of the user control identity enables the user control to govern the mode of operation corresponding to the selected identity.

2. The bed of claim 1 wherein the two or more modes of operation are selected from the group consisting of an elevation mode, an inclination mode, a weigh mode, an upper body rotational mode, a leg contour mode, a profile mode, a length mode, a mattress firmness mode and a turn assist mode.

3. The bed of claim 1 wherein the user control is at least one pedal.

4. The bed of claim 1 wherein the user control is a single rocking pedal.

5. The bed of claim 1 wherein the user control is a finger operated interface.

6. The bed of claim 1 wherein the user control is capable of assuming exactly two identities, one of the two identities corresponding to an elevation mode of operation and the other of the two identities corresponding to an upper body rotational mode whereby selection of the elevation mode enables the user control to govern an elevation of the bed and selection of the upper body rotational mode enables the user control to govern angular orientation of an upper body section of the bed.

7. The bed of claim 1 wherein the user control is capable of assuming exactly two identities, one of the two identities corresponding to an UP mode of operation and the other of the two identities corresponding to a DOWN mode whereby selection of the UP mode enables the user control to increase an elevation of the bed and an orientation angle of an upper body section of the bed and selection of the DOWN mode enables the user control to decrease the elevation of the bed and the orientation angle of the upper body section.

8. The bed of claim 6 wherein the user control is a pair of controls, a first member of the pair enabling a decrease in the elevation of the bed when the elevation mode is selected and a second member of the pair enabling an increase in the elevation of the bed when the elevation mode is selected, and the first member of the pair enabling a decrease in the angular orientation of the bed when the upper body rotational mode is selected and the second member of the pair enabling an increase in the angular orientation of the bed when the upper body rotational mode is selected.

9. The bed of claim 8 wherein each member of the pair of controls is a pedal.

10. The bed of claim 1 wherein the user control is capable of assuming exactly three identities, one of the three identities corresponding to an elevation mode of operation, a second identity corresponding to a leg profile mode of operation and a third identity corresponding to an upper body rotational mode of operation whereby selection of the elevation mode enables the user control to govern an elevation of the bed, selection of the leg profile mode enables the user control to govern angular orientation of thigh and calf deck sections of the bed, and selection of the upper body rotational mode enables the user control to govern angular orientation of an upper body section of the bed.
